(19) United States
(12) Patent Application Publication
(10) Pub. No.: US 2020/0215857 A1
(43) Pub. Date: Jul. 9, 2020

(54) TIRE SUITABLE FOR RUNNING FLAT, PROVIDED WITH AN ELECTRONIC UNIT

(71) Applicant: COMPAGNIE GENERALE DES ETABLISSEMENTS MICHELIN, Clermont-Ferrand (FR)

(72) Inventors: MATHIEU GRECO, Clermont-Ferrand (FR); SEVERINE GLIBERT, Clermont-Ferrand (FR); OLIVIER MUHLHOFF, Clermont-Ferrand (FR)

(21) Appl. No.: 16/625,261

(22) PCT Filed: Jun. 1, 2018
(86) PCT No.: PCT/FR2018/051273

§ 371 Date: Dec. 20, 2019

(30) Foreign Application Priority Data
Jun. 22, 2017 (FR) 1755689

(51) Int. Cl. B60C 17/00; B60C 15/00; B60C 3/06; B60C 25/00; B60C 19/00; H04B 1/59

(52) U.S. Cl. CPC B60C 17/0036; B60C 15/0009; B60C 3/06; B60C 25/002; H01Q 1/3291; H04B 1/59; B60C 2017/0063; B60C 2019/004; B60C 19/00

(57) ABSTRACT

Tyre suitable for running flat comprising a crown, two sidewalls and two beads, a carcass reinforcement anchored in each bead and a sidewall insert placed in each of the two sidewalls axially internally relative to the carcass reinforcement, such that it is equipped with an electronic device comprising at least one radiofrequency transponder and such that the electronic device is embedded in one of the sidewall inserts.

### FIELD OF THE INVENTION

The present invention relates to a tyre suitable for running flat and equipped with an electronic device.

### PRIOR ART

For several years, tyre manufacturers have sought to eliminate the need for the presence of a spare wheel on board the vehicle while at the same time guaranteeing that the vehicle will be able to continue its journey despite a significant or complete loss of pressure from one or more of the tyres. This, for example, allows a service centre to be reached without the need to stop, under circumstances that are often hazardous, in order to fit the spare wheel.

One envisaged solution is the use of run-flat tyres which are provided with self-supporting sidewalls (sometimes referred to by their trade designations “ZP” for “zero pressure” or “SST” for “self supporting tyre”).

A run-flat tyre comprising a crown comprising a crown reinforcement, which reinforcement is formed of two crown plies of reinforcing elements and surmounted by a tread, is known from the prior art. Two sidewalls extend the crown radially inwards. These sidewalls are reinforced by rubber inserts that are able to support a load at reduced pressure or even with no pressure.

The tyre further comprises two beads each one comprising a bead wire and a carcass reinforcement extending from the beads through the sidewalls to the crown and comprising at least one carcass ply of reinforcing elements. The carcass ply is anchored to each of the beads via a turn-up about the bead wire.

When the inflation pressure is significantly reduced in comparison with the service pressure, or is even zero (this is then referred to as “run-flat” mode), the tyre must make it possible to cover a given distance at a given speed. This performance, referred to as “ERM” (extended running mode) performance, is required by legislation or by motor vehicle manufacturers in order to allow the producer to advertise the tyre as being a run-flat tyre.

When the inflation pressure is close to the service pressure (this is then referred to as “normal running” mode), it is desirable for the tyre to exhibit performance, referred to as “IRM” (inflated running mode) performance, that is as high as possible. This IRM running performance includes, amongst other things, the mass, the rolling resistance or even the comfort.

Furthermore, it is advantageous to equip tyres with electronic identification devices that allow them to be identified and tracked during the manufacture thereof, the storage thereof, the entirety of the lifetime thereof and also during retreading thereof.

The tyres in question are tyres for heavy goods vehicles, passenger vehicles, construction equipment, agricultural machinery, and aeroplanes.

Such electrical devices may be radiofrequency transponders or radiofrequency identification (RFID) transponders.

These electronic devices must be placed very precisely in order to guarantee good radiofrequency communication, an acceptable device lifetime and in order not to penalize the operation or the endurance of the tyres.

The particular conditions of use of tyres able to run flat when running flat makes it particularly difficult to introduce such electronic devices into these types of tyres.

### BRIEF DESCRIPTION OF THE INVENTION

The subject of the invention is a tyre suitable for running flat, the tyre comprising a crown, two sidewalls and two beads, a carcass reinforcement anchored in each bead and a sidewall insert placed in each of the two sidewalls axially internally relative to the carcass reinforcement. This tyre is characterized in that it is equipped with an electronic device comprising at least one radiofrequency transponder embedded in the interior of one of the sidewall inserts.

In the interior of the sidewall insert, mechanical stresses are low when running in inflated mode because of the high rigidity of the rubber from which the sidewall insert is made. This allows the electronic device to have a good fatigue resistance.

Another undeniable advantage is that during the life of a tyre in normal, inflated, mode the latter is able to undergo many curb scrapes. In the most severe cases (taxis, etc.) the sidewall my even wear down to 80% of its thickness as-new. Such a position, in the interior of the sidewall flanks, is therefore very advantageous, because naturally protected from curb scrapes. Furthermore, when tyres are caused to mount onto curbs, the sidewalls undergo very large deformations: they adopt the shape of the curb while rolling thereover. When a curb possesses a sharp edge, with a blending radius smaller than 5 mm, if the electronic device is located between the sidewall and the carcass-ply reinforcement, there is a potential risk that it will be destroyed. A sidewall insert increases the rigidity of the sidewall, and decreases the deformation of the sidewall when a tyre mounts a curb. The best place for an electronic device is therefore in the interior of the sidewall insert, rather than in the bead, and above the rim flange.

Advantageously, the sidewall insert being composed of two circumferential and axially adjacent rubber masses, the electronic device is placed at the interface between the two rubber masses of the sidewall insert.

Placement at the interface between the two rubber masses from which the sidewall insert is formed is advantageous because it is easy to position the electronic device during the manufacture of the tyre at this interface.

Advantageously, each bead comprising a bead wire of revolution about a reference axis and H being one of the points of said bead wire closest to the axis of revolution, the electronic device is placed at a radial distance larger than 20 mm from the point H.

This position makes it possible to guarantee the quality of the electromagnetic communication with a receiver external to the tyre. The wheel on which the tyre is mounted is in general made of metal and a position too close thereto could disrupt the communication. It will be noted that the height of conventional rim flanges is 17.5 mm and beyond a radial distance of 20 mm from the point H, the electromagnetic disruption of the rim flange becomes minimal.

According to a preferential embodiment, the electronic device is placed radially in a zone representing between 20 and 70% of the section height of said tyre.

Very advantageously, the electronic device is placed radially in a zone representing between 30 and 60% of the section height SH of the tyre.

Because of the high stiffness of the sidewall inserts, it is possible to install the electronic device in this zone of the tyre. This zone makes it possible to obtain an optimal radiofrequency communication between the electronic device and an external receiver.

Advantageously, the sidewall insert has a maximum thickness comprised between 6 and 16 mm.

The electronic device may consist of a radiofrequency transponder. It may also consist of a radiofrequency transponder encapsulated in an electrically insulating encapsulating rubber mass.

It is necessary for correct radiofrequency operation of the radiating antenna of the electronic device, for said antenna to be embedded in a mass of electrically insulating encapsulating rubber. It is thus possible to use a semi-finished element consisting of a radiofrequency transponder embedded in a mass of electrically insulating rubber to place it into the structure of the tyre during its manufacture in the chosen place.

However, it is also possible to directly place the radiofrequency transponder between two blends of the tyre when said blends, because of their formulation, are electrically insulating.

Preferably, the elastic modulus of the encapsulating rubber mass is lower than or equal to the elastic modulus of the adjacent rubber blends.

According to another aspect, the relative dielectric constant of the encapsulating rubber mass is lower than the relative dielectric constant of the adjacent rubber blends.

The radiofrequency transponders conventionally comprise an electronic chip and a radiating antenna able to communicate with an external radiofrequency reader.

According to a first embodiment, the radiating antenna comprising two helical antenna segments, and the electronic chip is galvanically connected to the two helical antenna segments.

According to another embodiment, the radiofrequency transponder in addition comprises a primary antenna electrically connected to the electronic chip, wherein the primary antenna is inductively coupled to the radiating antenna, and wherein the radiating antenna is a dipole antenna consisting of a single-strand helical spring.

This second embodiment has the advantage of mechanically disassociating the radiating antenna from the electronic components of the transponder and thus of avoiding the weak point of conventional transponders, namely the zone in which the antenna segments are fastened to the carrier of the electronic chip. The integration of such an electronic device into a tyre allows the risk of deterioration of the device, because of its structure, to be decreased while improving radiocommunication performance and minimizing the related risks to the physical integrity of the tyre.

Specifically, deterioration of the electronic device is generally caused by failures in the electrical connections that exist between the communication radiating antenna and the electronic portion of the device. Here, no mechanical connection is required since the transfer of energy between the communication antenna and the electronic chip is achieved with an electromagnetic field, via a primary antenna. However, although the size of the radiating antenna, which is related to the frequency band of communication and to its far-field operation, is by nature large, the primary antenna is not subjected to this constraint. Thus it is of smaller size, in general allowing the deformations of the tyre to be easily endured without generation of excessively high mechanical stresses within the galvanic junction between it and the electronic chip. Lastly, the supple nature of the radiating antenna limits the risks of the deterioration of the zone of the tyre close to the transponder.

Secondly, the introduction of the primary antenna makes it possible to disassociate contradictory constraints on the size of the radiating antenna and the electrical impedance of the electronic portion of the device. Thus, it is possible to dimension the primary antenna in order to match its electrical impedance to that of the chip in order to minimize losses and to therefore improve the performance of the electronic device in terms of power consumption. The dimensions of the radiating antenna are then chosen solely with respect to the criterion of the communication frequency of the electronic device. All of this tends to improve the radiocommunication performance of the electronic device.

According to one preferred embodiment, the radiating antenna defining a first longitudinal axis, the primary antenna is a coil having at least one turn defining a second longitudinal axis that is circumscribed in a cylinder the axis of revolution of which is parallel to the second longitudinal axis and the diameter of which is comprised between one third and three times, and preferably between half and two times, the average diameter of the helical spring of the radiating antenna.

Thus, the primary antenna being a loop antenna, energy is mainly transferred between the radiating antenna and the primary antenna by inductive coupling. This requires a certain proximity (in order to limit the gap between the two antennas) between the two antennas, requiring the coil of the primary antenna to be dimensioned, with respect to the radiating antenna, in order to ensure a transfer of energy that is sufficiently effective to obtain the desired radiocommunication quality. Concretely, the primary antenna may advantageously be of diameter smaller than that of the radiating antenna; in this case the entirety of the electronic portion of the transponder is inserted into the radiating antenna and the assembly is then particularly robust in an environment such as that of a tyre.

The antenna may also be of diameter larger than that of the radiating antenna; this case is particularly advantageous when it is desired to add, to the radiofrequency transponder, other, active or passive, electronic components in order to allow additional functions, such as for example surveillance of the state of the tyre, to be added.

According to one advantageous embodiment, the radiating antenna having a central zone between two lateral zones and the primary antenna having a median plane perpendicular to the second longitudinal axis, the first and second longitudinal axes are parallel to each other and the median plane of the primary antenna is placed in the central zone of the radiating antenna.

Thus, it is ensured that the distance between the radiating and primary antennas is constant along the longitudinal axes of these antennas, thus optimizing level with each element of length of the primary antenna an equivalent transfer of energy. In addition, the magnetic field created by a coil through which an electric current flows being maximum at the centre of the length of the coil (in the case of a λ/2 antenna), it is preferable to place the median plane of the primary antenna in the central zone of the radiating antenna and more preferably at the centre thereof in order to maximize the magnetic field that is the origin of the inductive coupling.

Preferably, in the case of tyres able to run flat, the primary antenna is placed in the interior of the single-strand helical spring of the radiating antenna.

It is advantageous, when the tyre is directional, i.e. it has a defined running direction without having a defined inner or outer side for mounting on a vehicle, to place an electronic device in each of the two sidewall inserts. Independently of the way in which the tyre is mounted, communication between one of the electronic devices and an external receiver will be easy.

It is also advantageous, when the tyre has an outer side E intended to be placed toward the exterior of a vehicle and an inner side intended to be placed toward the interior of a vehicle, to place the electronic device in the sidewall insert on the outer side of the tyre.

This makes it possible to facilitate communication between the electronic device and its radiofrequency transponder and an external receiver.

### DESCRIPTION OF THE FIGURES

The various subjects of the present invention will be better understood by means of the following detailed description and the attached drawings, the same reference numbers having been used in all the drawings to reference identical parts, and in which drawings:

FIG. 1 illustrates in partial axial cross section a tyre able to run flat and equipped with an electronic device;

FIG. 2 illustrates another embodiment of the tyre of FIG. 1;

FIG. 3 is a conventional radiofrequency transponder;

FIG. 4 is a schematic exploded view of an electronic device according to a second embodiment;

FIG. 5 is a perspective view of a radiofrequency transponder according to one embodiment of the invention in a configuration in which the electronic portion is located in the interior of the radiating antenna;

FIG. 6 is a perspective view of a radiofrequency transponder according to the invention in a configuration in which the electronic portion is located on the exterior of the radiating antenna;

FIG. 7 is a detail view of a radiating antenna of a radiofrequency transponder according to one embodiment of the invention; and

FIG. 8 is a perspective view of the electronic portion of a radiofrequency transponder in a configuration in which the electronic portion is located in the interior of the radiating antenna.

### DETAILED DESCRIPTION OF THE INVENTION

Hereinafter, the terms “rubber blend”, “rubber” and “blend” are used equivalently to indentify rubber constituents of the tyre.

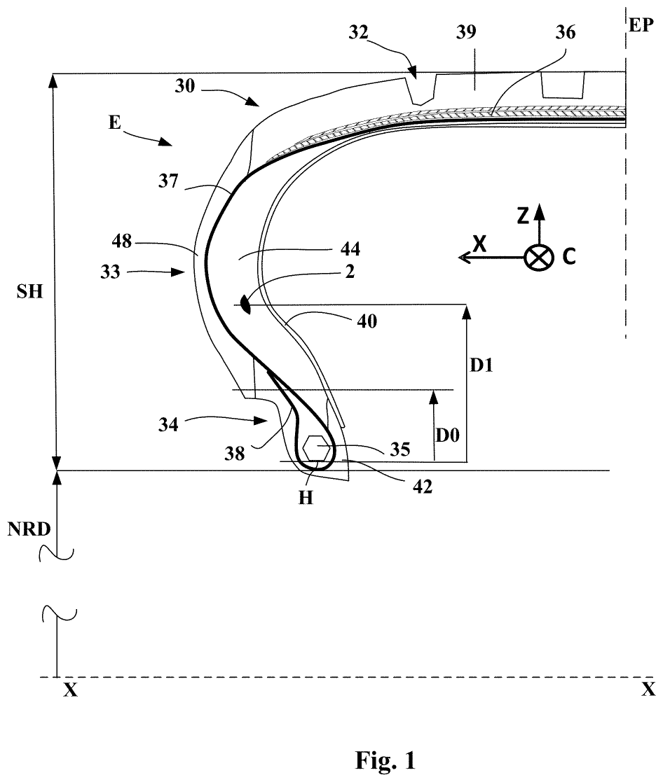

FIG. 1 indicates the axial X, circumferential C and radial Z directions and also the median plane EP (plane perpendicular to the axis of rotation of the tyre which is situated halfway between the two beads of the tyre and passes through the middle of the crown reinforcement) and the axis of rotation XX of the tyre 30.

This figure also shows the section height SH of the tyre, i.e. the radial distance between the nominal diameter of the mounting rim of the tyre NRD and the radially outermost portion of the tread of the tyre. In the context of this invention, the nominal diameter of the mounting rim of the tyre is taken to be the diameter of the tyre as indicated by its size.

In all the figures, the tyre is shown free, not mounted on a rim and such that the width between the two beads is decreased to the width of the nominal ETRTO rim.

As regards the axial direction, what is meant by “axially external” is an axial direction directed toward the exterior of the tyre and by “axially internal” what is meant is an axial direction directed toward the median plane EP of the tyre.

This run-flat tyre 30 comprises a crown 32 reinforced by a crown reinforcement or belt 36, a sidewall 33 and a bead 34, the bead 34 being reinforced with a bead wire 35. The crown reinforcement 36 is surmounted radially externally by a rubber tread 39. A carcass reinforcement 37 is wound around the bead wire 35 in the bead 34, the turn-up 38 of this reinforcement 37 being, for example, arranged towards the exterior of the tyre 30. In a manner known per se, the carcass reinforcement 37 is made up of at least one ply reinforced by what are known as “radial” cords, for example here of textile, that is to say that these cords are disposed virtually parallel to one another and extend from one bead to the other so as to form an angle of between 80° and 90° with the median circumferential plane EP. An airtight inner liner 40 extends from one bead to the other radially internally with respect to the carcass reinforcement 37. The bead 34 comprises a protective rubber (or “protector”) 42 able to make contact with the surface of a rim. It also comprises a first filling rubber 46 extending radially externally relative to the bead wire 35.

The tyre 30 is able to run flat because of the presence of a sidewall insert 44 placed axially internally relative to the carcass reinforcement 37. This insert 44 allows the structure of the tyre to withstand the load thereon at zero pressure. The order of magnitude of the elastic modulus of the rubber of a sidewall insert is of the order of twice the value of the modulus of a sidewall rubber or greater.

The sidewall insert 44 of FIG. 1, comprises an electronic device 2 placed at a radial distance D1 from the point H. The point H is one of the points closest to the axis of rotation XX. The distance D must be larger than D0 equal to 20 mm in order not to penalize the communication quality between the electronic device and an external reader. This distance is larger than the height of a conventional rim flange, which is 17.5 mm.

The electronic device 2 is embedded in the interior of the sidewall insert 44. On account of the high modulus of the rubber from which the sidewall insert is made, which is necessary to ensure the bearing capacity of the tyre and of the vehicle when running flat, the electronic device is stressed only little in inflated running mode, and thus has an acceptable service lifetime.

The electronic unit is preferably placed in the semi-finished sidewall insert before its incorporation into the green tyre.

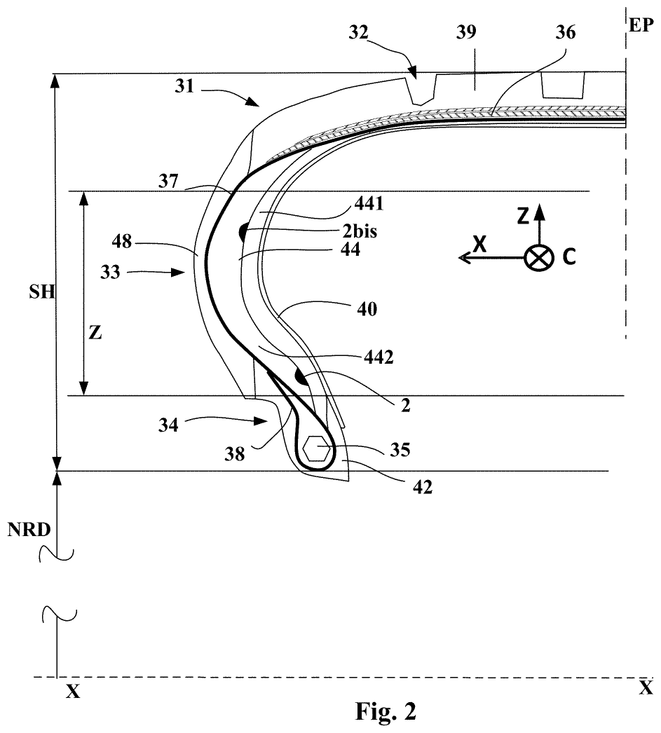

FIG. 2, which is similar to FIG. 1, shows in partial axial cross section a tyre 31 suitable for running flat and the structure of which is almost identical to that of the tyre 30 of FIG. 1. The sidewall insert 44, in this example, is made up of two rubber masses 441 and 442 that are axially adjacent to each other and the electronic devices 2 and 2bis are placed at the interface between the two rubber 441 and 442.

This embodiment facilitates precise and reproducible positioning of the electronic devices during the manufacture of the tyre.

FIG. 2 illustrates the zone Z of the section height SH of the tyre in which it is preferable to position the electronic devices. This zone Z lies between 20 and 70% SH. The electronic device 2 is placed at about 25% SH and the device 2bis at 60%.

In FIG. 1, the electronic device is placed at about 45% SH.

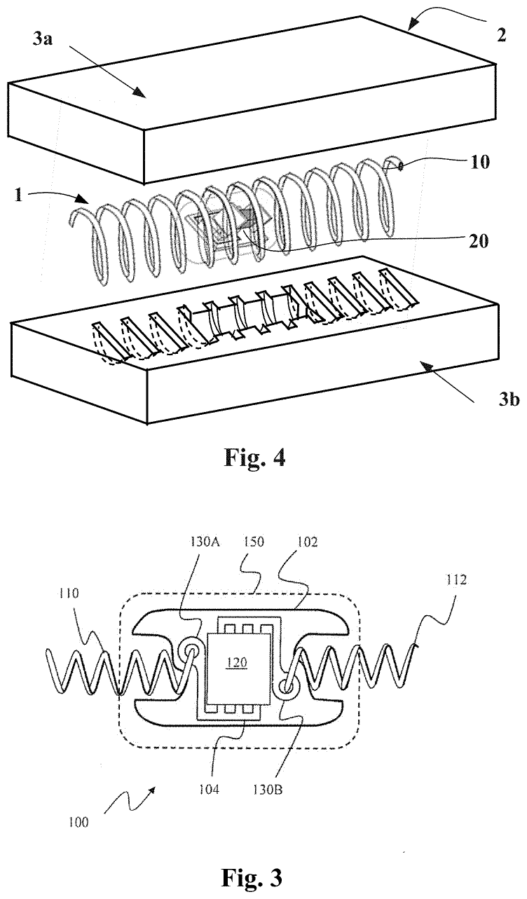

FIG. 3 shows a conventional radiofrequency transponder such as described in document WO2009134243 A1.

FIG. 4 is an exploded view of an electronic device 2. This device 2 comprises a radiofrequency transponder 1 embedded between two layers 3a and 3b of a non-vulcanized electrically insulating elastomer blend. Such an electronic device is a semi-finished product able to be integrated into the structure of a tyre during the manufacture thereof.

The encapsulating elastomer blend contains 100 phr (parts per 100 parts of elastomer by mass) of a polymer such as EPDM (ethylene propylene diene monomer rubber), butyl rubber, neoprene or a diene elastomer such as SBR (styrene-butadiene rubber), polybutadiene, natural rubber or polyisoprene.

The blend may contain fillers such as fillers of silica, carbon black, chalk and kaolin type:
with a filler of silica type in a maximum amount of 50 phr;
with a filler of the type consisting of carbon black of ASTM grade higher than 700, in an amount lower than 50 phr;
with a filler of the type consisting of carbon black of grade lower than or equal to 500, in a maximum amount of 20 phr.
It is possible to add or replace these fillers with chalk or kaolin.

Such amounts and types of fillers make it possible to guarantee a relative permittivity lower than 6.5, in particular at a frequency of 915 MHz.

The stiffness in the cured state of the encapsulating blend is preferably lower than or close to those of the adjacent blends.

In a first embodiment, the radiofrequency transponder of the electronic device 2 is a conventional radiofrequency transponder, such as described in document WO2009134243A1. This transponder 100 comprises an electronic chip 120 fastened to a carrier or printed circuit board (PCB) 102 and galvanically connected via conductive tracks 104, 130A and 130B to two half-antennas 110 and 112. The antennas are helical springs the solid core of which is a steel wire. The outline 150 refers to layers of non-conductive rubber that covers the PCB, the electronic chip and at least a portion of the two half-antennas.

The radiofrequency transponder 1 of the electronic device 2 such as shown in FIG. 4 corresponds to a second embodiment of the electronic device 2 that will now be described.

The radiofrequency transponder 1 according to the second embodiment of the electronic device 2 comprises an electronic chip 22 and a radiating antenna 10 able to communicate with an external radiofrequency reader. It in addition comprises a primary antenna 24 electrically connected to the electronic chip 22 and inductively coupled to the radiating antenna 10. The radiating antenna is a dipole antenna consisting of a single-strand helical spring defining a first longitudinal axis.

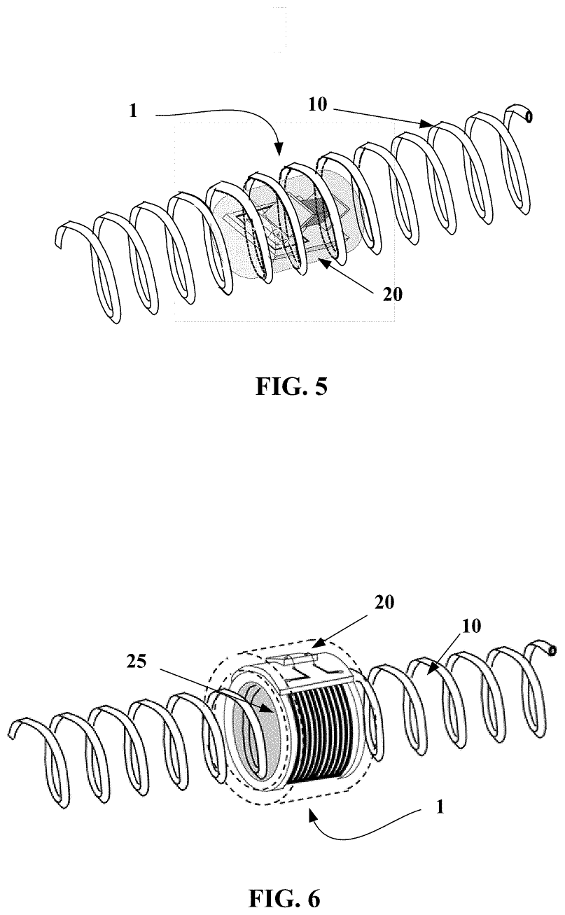

FIG. 5 shows a radiofrequency transponder 1 in a configuration in which the electronic portion 20 is located in the interior of the radiating antenna 10. The geometric shape of the electronic portion 20 is circumscribed in a cylinder the diameter of which is smaller than or equal to the inside diameter 13 of the helical spring 10. The introduction of the electronic portion 20 into the radiating antenna 10 is facilitated thereby. The median plane 21 of the primary antenna is located in the central zone of the radiating antenna and substantially superposed on the median plane 19 of the radiating antenna 10.

FIG. 6 shows a radiofrequency transponder 1 in a configuration in which the electronic portion 20 is located on the exterior of the radiating antenna 10. The geometric shape of the electronic portion 20 has a cylindrical cavity 25 the diameter of which is larger than or equal to the outside diameter 15 of the radiating antenna 10. The introduction of the radiating antenna 10 into the cylindrical cavity 25 of the electronic portion is thus facilitated thereby. The median plane 21 of the primary antenna is located in the central zone of the radiating antenna and substantially in line with the median plane 19 of the radiating antenna 10.

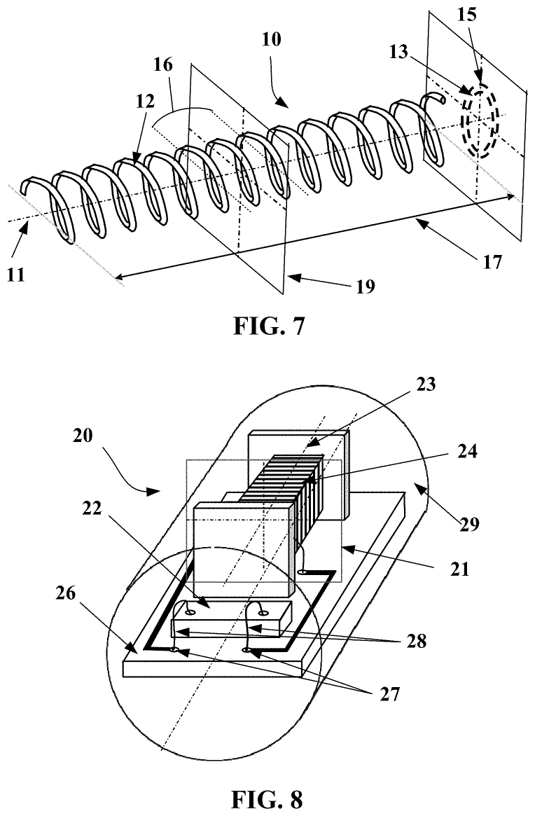

FIG. 7 shows a radiating antenna 10 consisting of a steel wire 12 that has been plastically deformed in order to form a helical spring having an axis of revolution 11. This steel wire is coated with a conduction layer made of copper, aluminium, silver, zinc or brass covered if necessary with a chemically insulating layer for example made of brass, zinc, nickel or tin in order to protect the rubber blend from the material of the conduction layer.

The electromagnetic conduction of such an antenna occurs mainly via a skin effect, i.e. it mainly occurs in the exterior layers of the antenna. This thickness of skin is in particular dependent on the frequency of the radiation and of the material from which the conduction layer is made. By way of example, for a UHF frequency (for example 915 MHz), the skin thickness is about 2.1 μm for silver, 2.2 μm for copper, and 4.4 μm for brass.

The steel wire may be coated with these layers then formed; alternatively it may also be formed then coated.

The helical spring is primarily defined by a winding diameter of the coated wire and by a helix pitch. Thus, given the diameter of the wire, the inside diameter 13 and outside diameter 15 of the helical spring may be precisely determined. The length 17 of the spring 10 here corresponds to one half-wavelength of the transmission signal of the radiofrequency transponder 1 in a rubber mass. It is furthermore possible to define a median plane 19 of the helical spring 10 perpendicular to the axis of revolution 11 separating the radiating antenna into two equal portions. This plane is in the middle of the central zone 16 of the radiating antenna, this central zone 16 corresponding to about 25% of the total length of the antenna and preferably 15%.

FIG. 8 shows the electronic portion 20 of a radiofrequency transponder 1 intended for a configuration in which the electronic portion 20 is located in the interior of the radiating antenna 10. The electronic portion 20 comprises an electronic chip 22 and a primary antenna 24 that is electrically connected to the electronic chip 22 via a printed circuit board 26. The primary antenna here consists of a surface-mount-device (SMD) microcoil having an axis of symmetry 23. The median plane 21 of the primary antenna is defined by a normal parallel to the axis of symmetry 23 of the SMD coil and separates the coil into two equal portions. The components on the printed circuit board are electrically connected using tracks made of copper terminated by copper pads 27. The components on the printed circuit board are electrically connected using the wire-bonding technique by gold wires 28 running between the component and the pads 27. The assembly consisting of the printed circuit board 26, the electronic chip 22 and of the primary antenna 24 is embedded in a rigid mass 29 made of electrically insulating high-temperature epoxy resin, and forms the electronic portion 20 of the radiofrequency transponder 1.

This radiofrequency transponder 1 has the advantage of being much more mechanically resistant than conventional transponders and thus is particularly suitable for a hostile use such as encountered with run-flat tyres.

1.-18. (canceled)

19. A tire suitable for running flat, the tire comprising a crown, two sidewalls and two beads, a carcass reinforcement anchored in each bead and a sidewall insert placed in each of the two sidewalls axially internally relative to the carcass reinforcement,
wherein the tire is equipped with an electronic device comprising at least one radiofrequency transponder, and
wherein the electronic device is embedded in one of the sidewall inserts.

20. The tire according to claim 19, wherein the one of the sidewall inserts is composed of two circumferential and axially adjacent rubber masses, and the electronic device is placed at an interface between the two rubber masses of one of the sidewall inserts.

21. The tire according to claim 19, wherein each bead comprises a bead wire of revolution about a reference axis, wherein H is one of the points of the bead wire closest to the reference axis, and wherein the electronic device is placed radially externally at a radial distance larger than 20 mm from H.

22. The tire according to claim 19, wherein the electronic device is placed radially in a zone representing between 20 and 70% of a section height of the tire.

23. The tire according to claim 22, wherein the electronic device is placed radially in a zone representing between 30 and 60% of the section height of the tire.

24. The tire according to claim 19, wherein the sidewall insert has a maximum thickness between 6 and 16 mm.

25. The tire according to claim 19, wherein the electronic device consists of the radiofrequency transponder.

26. The tire according to claim 19, wherein the electronic device consists of the radiofrequency transponder encapsulated in at least one electrically insulating encapsulating rubber mass.

27. The tire according to claim 26, wherein an elastic modulus of the encapsulating rubber mass is lower than or equal to an elastic modulus of adjacent rubber blends.

28. The tire according to claim 26, wherein a relative dielectric constant of the encapsulating rubber mass is lower than a relative dielectric constant of adjacent rubber blends.

29. The tire according to claim 19, wherein the radiofrequency transponder of the electronic device comprises an electronic chip and a radiating antenna able to communicate with an external radiofrequency reader.

30. The tire according to claim 29, wherein the radiating antenna comprises two helical antenna segments, and the electronic chip is galvanically connected to the two helical antenna segments.

31. The tire according to claim 29, wherein the radiofrequency transponder of the electronic device further comprises a primary antenna electrically connected to the electronic chip,
wherein the primary antenna is inductively coupled to the radiating antenna, and
wherein the radiating antenna is a dipole antenna consisting of a single-strand helical spring defining a first longitudinal axis.

32. The tire according to claim 31, wherein the primary antenna is a coil having at least one turn defining a second longitudinal axis that is circumscribed in a cylinder the axis of revolution of which is parallel to the second longitudinal axis and the diameter of which is between one third and three times the average diameter of the helical spring of the radiating antenna.

33. The tire according to claim 32, wherein the radiating antenna has a central zone between two lateral zones and the primary antenna has a median plane perpendicular to the second longitudinal axis,
wherein the first and second longitudinal axes are parallel to each other, and
wherein the median plane of the primary antenna is placed in the central zone of the radiating antenna.

34. The tire according to claim 31, wherein the primary antenna is placed in an interior of the single-strand helical spring of the radiating antenna.

35. The tire according to claim 19, wherein the tire has a preferential running direction, and an electronic device is placed in each of the two sidewall inserts.

36. The tire according to claim 19, wherein the tire has an outer side and an inner side for mounting on a vehicle, and the electronic device is placed in the sidewall on the outer side of the tire.
